(19) United States
(12) Patent Application Publication
(10) Pub. No.: US 2017/0249108 A1
(43) Pub. Date: Aug. 31, 2017

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Hiroaki NAKATA, Kawasaki-shi (JP)

(21) Appl. No.: 15/433,799

(22) Filed: Feb. 15, 2017

(30) Foreign Application Priority Data
Feb. 25, 2016 (JP) 2016-034835

(51) Int. Cl. G06F 3/12

(52) U.S. Cl. CPC G06F 3/1209; G06F 3/1225; G06F 3/1286

(57) ABSTRACT

In an information processing apparatus according to an exemplary embodiment, a printer driver receives document data, determines whether a meta image is present in the document data, wherein the meta image in which metadata is saved in an area for storing information different from information about rendering an image, and acquires the metadata included in the meta image from the document data, in a case where it is determined that the meta image is present in the document data.

### BACKGROUND

Field of Art

The present disclosure relates to a technique for communication between an application and a printer driver.

Description of the Related Art

Techniques for communicating arbitrary data other than print data between an application and a printer driver have been conventionally discussed. Japanese Patent Application Laid-Open No. 10-248014 discusses a technique for performing a system call using ExtEscape, as a method for allowing an application to determine whether a printer driver supports an image server interface.

### SUMMARY

According to an aspect of the present disclosure, an information processing apparatus includes a printer driver. The printer driver includes a receiving unit configured to receive document data, a determination unit configured to determine whether a meta image is present in the document data, wherein the meta image in which metadata is saved in an area for storing information different from information about rendering an image, and an acquisition unit configured to acquire the metadata included in the meta image from the document data, in a case where the determination unit determines that the meta image is present in the document data.

Further features will become apparent from the following description of exemplary embodiments with reference to the attached drawings.

### BRIEF DESCRIPTION OF THE DRAWINGS

FIG. 1 illustrates an example of a device configuration to which a print system according to an exemplary embodiment is applicable.

FIG. 2 is a block diagram illustrating a hardware configuration related to the print system according to the present exemplary embodiment.

FIGS. 3A and 3B are diagrams each illustrating a data flow related to print processing of a software module.

FIG. 4 is a flowchart illustrating a flow of processing of an application.

FIGS. 5A and 5B are schematic diagrams each illustrating a data example of a meta image.

FIG. 6 is a flowchart illustrating a flow of processing of Microsoft XPS Document Converter (MXDC), where XPS stands for XML Paper Specification, in which XML stands for eXtensible Markup Language.

FIG. 7 is a schematic diagram illustrating a data example of XPS.

FIG. 8 is a flowchart illustrating a flow of processing of a filter.

FIG. 9 is a schematic diagram illustrating print processing of an application and a page image.

### DESCRIPTION OF THE EMBODIMENTS

The exchange of arbitrary data using ExtEscape discussed in Japanese Patent Application Laid-Open No. 10-248014 is not supported by a module for print processing, in some version of a print system in which the printer driver operates. In this case, necessary communication cannot be performed between the application and the printer driver, and therefore a desired function cannot be implemented.

The present disclosure is directed to communication of arbitrary data, performed between an application and a printer driver, regardless of the version of a print system.

An exemplary embodiment will be described in detail below with reference to the drawings.

In Windows® 8 of Microsoft®, a printer driver can be developed based on a new architecture called a V4 printer driver in addition to a V3 printer driver.

In the V4 printer driver, a Microsoft-predefined document format called eXtensible Markup Language (XML) Paper Specification (XPS) is used for rendering data.

Graphics Driver Interface (GDI) and XPS are different in terms of a rendering system. However, since a conversion module called Microsoft XPS Document Converter (MXDC) for converting GDI into XPS is provided, an application can perform printing in the V4 printer driver while keeping GDI.

The V3 printer driver has a capability of processing not only a rendering command as application programming interface (API) of GDI, but also API of ExtEscape for transmitting arbitrary data. However, as will be described in detail below, MXDC serving as the conversion module cannot receive arbitrary data using ExtEscape.

In other words, an application may perform communication control using ExtEscape in combination with the V3 printer driver, but cannot perform this communication control in combination with the V4 printer driver.

Therefore, a method for performing communication between the application and the V4 printer driver without using ExtEscape will be described below.

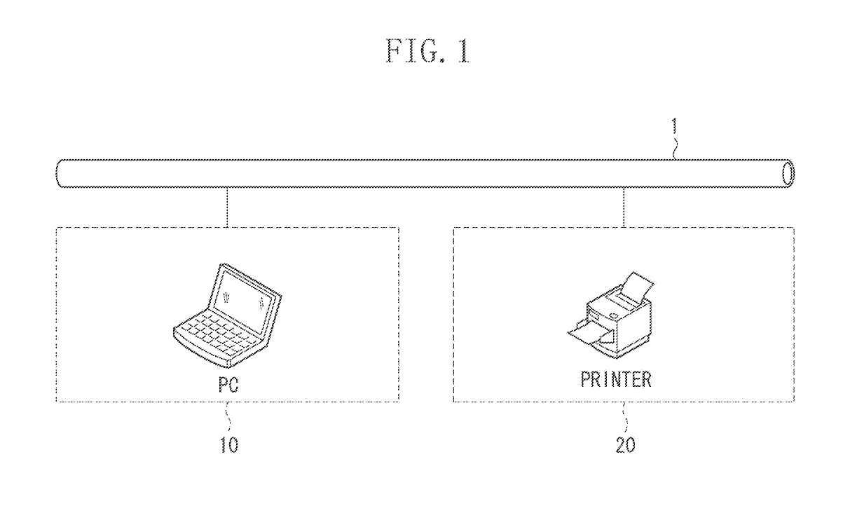

FIG. 1 is a diagram illustrating an example of a device configuration to which a print system according to the present exemplary embodiment is applicable. The print system includes a personal computer (PC) 10 and a printer 20. The PC 10 is an example of an information processing apparatus. The PC 10 and the printer 20 are connected via a local area network (LAN) 1. The LAN 1 supports a communication scheme of Ethernet. The LAN 1 may be either wired or wireless. Instead of LAN, other connection configuration, e.g., Bluetooth® or Universal Serial Bus (USB) may be adopted.

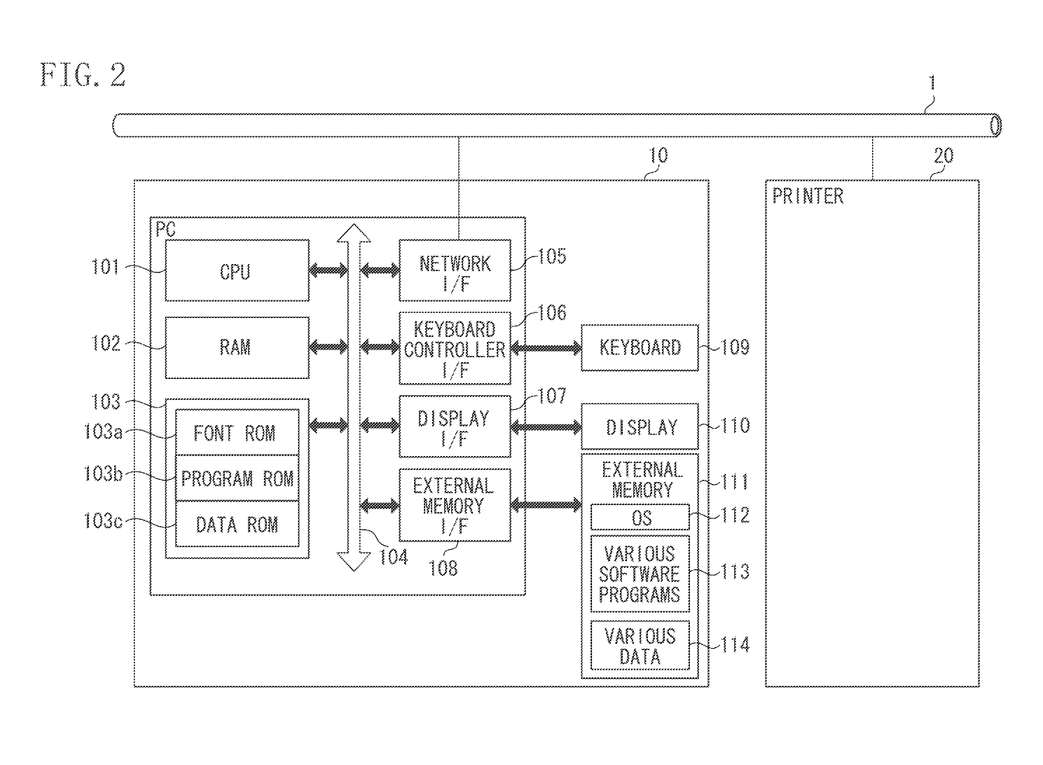

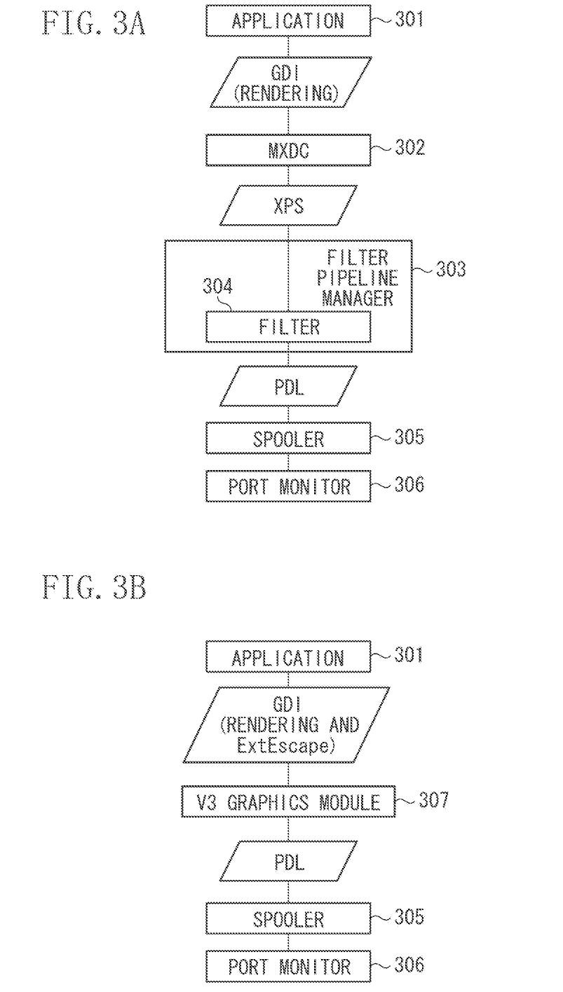

FIG. 2 is a block diagram illustrating a hardware configuration applicable to the PC 10. A central processing unit (CPU) 101 comprehensively controls each device connected to a system bus 104 according to a program stored in a random access memory (RAM) 102. In addition, the CPU 101 executes processing based on a program stored in an external memory 111. The CPU 101 thereby implements a software configuration of the PC 10 as illustrated in FIGS. 3A and 3B, and each step of flowcharts to be described below. The RAM 102 also functions as a main memory or a work area of the CPU 101. A read only memory (ROM) 103 stores various programs and data. The ROM 103 is segmented into a font ROM 103a, a program ROM 103b, and a data ROM 103c. The font ROM 103a stores various fonts. The program ROM 103b stores programs including a boot program and a basic input output system (BIOS). The data ROM 103c stores various data. A network interface (I/F) 105 is connected to the LAN 1, and performs communication processing. A keyboard controller I/F 106 controls a key input from a keyboard 109 or a pointing device such as a mouse (not illustrated). A display I/F 107 controls display processing for a display 110. An external memory I/F 108 controls access to the external memory 111 such as a hard disk (HD). The external memory 111 functions as a storage medium that stores an operating system (OS) 112, various software programs 113, and various data 114. The various software programs 113 implement the print system according to the present exemplary embodiment. Examples of the various data 114 include a user file and an edit file. In the description of the present exemplary embodiment, Microsoft Windows® 8 will be used as an example of the OS 112.

FIG. 3B is a diagram illustrating a data flow of a software module related to print processing of the V3 printer driver using GDI. An application 301 is a software program for creating document data, and receiving a print instruction via a print dialog. Upon receiving a print instruction from a user, the application 301 transmits a rendering command for document data to a V3 graphics module 307 using API of GDI. The V3 printer driver using GDI has no step for converting GDI into XPS. The V3 graphics module 307 directly converts GDI into a printer description language (PDL). The PDL is print data for performing print processing in the printer 20. The V3 graphics module 307 then outputs this PDL. A spooler 305 buffers the output PDL, and then a port monitor 306 transmits the PDL to the printer 20.

FIG. 3A is a diagram illustrating a data flow of a software module related to print processing of the V4 printer driver. Upon receiving a print instruction from a user, the application 301 transmits a rendering command for document data to a MXDC 302 using API of GDI. The MXDC 302 converts the GDI received from the application 301 into XPS, and then transmits the XPS to a filter pipeline manager 303. In the V4 printer driver, the print processing is executed according to an architecture called an XPS print filter pipeline. The unit of an internal component in the XPS print filter pipeline is called a filter. One or a plurality of filters included in the printer driver are sequentially linked by the filter pipeline manager 303 and executed. In other words, an output of a certain filter is an input of the next filter connected to this filter, and the filters sequentially execute processing, thereby generating a PDL to be transmitted to the printer 20. In the present exemplary embodiment, the print processing is performed using one filter 304 for performing conversion from XPS to PDL. The spooler 305 buffers the PDL output by the filter, and the port monitor 306 transmits the PDL to the printer 20.

Now, there will be described a difference between these two cases, in terms of communication between the application and the printer driver. The V3 graphics module 307 described with reference to FIG. 3B has a capability of processing API of ExtEscape for transmitting arbitrary data. The MXDC 302 described with reference to FIG. 3A also supports API of ExtEscape, but cannot receive metadata using ExtEscape. The metadata will be described below. It is desirable to provide a solution to such a difference in terms of a software module configuration and capability related to ExtEscape. For example, in the V4 printer driver, arbitrary data may be transmitted from the application 301 in a way replacing ExtEscape, and then received by the filter 304 to be processed.

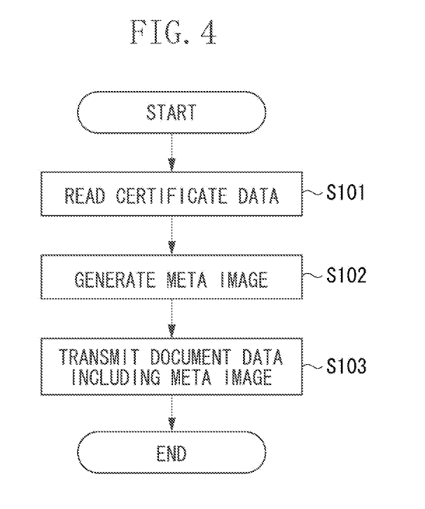

FIG. 4 is a flowchart illustrating print processing of the application 301 in the present exemplary embodiment. In step S101, the application 301 reads arbitrary data from the external memory 111. The arbitrary data is to be transmitted to the V4 printer driver. In the present exemplary embodiment, a system in which a PDL to be transmitted from the PC 10 to the printer 20 is encrypted using an encryption certificate will be described as an example. Therefore, the arbitrary data is hereinafter referred to as an “encryption certificate”. In subsequent processing, the application 301 transmits the encryption certificate to the filter 304. The filter 304 encrypts the PDL by the encryption certificate, and then transmits the encrypted PDL to the printer 20. The printer 20 decrypts the PDL by a decryption certificate.

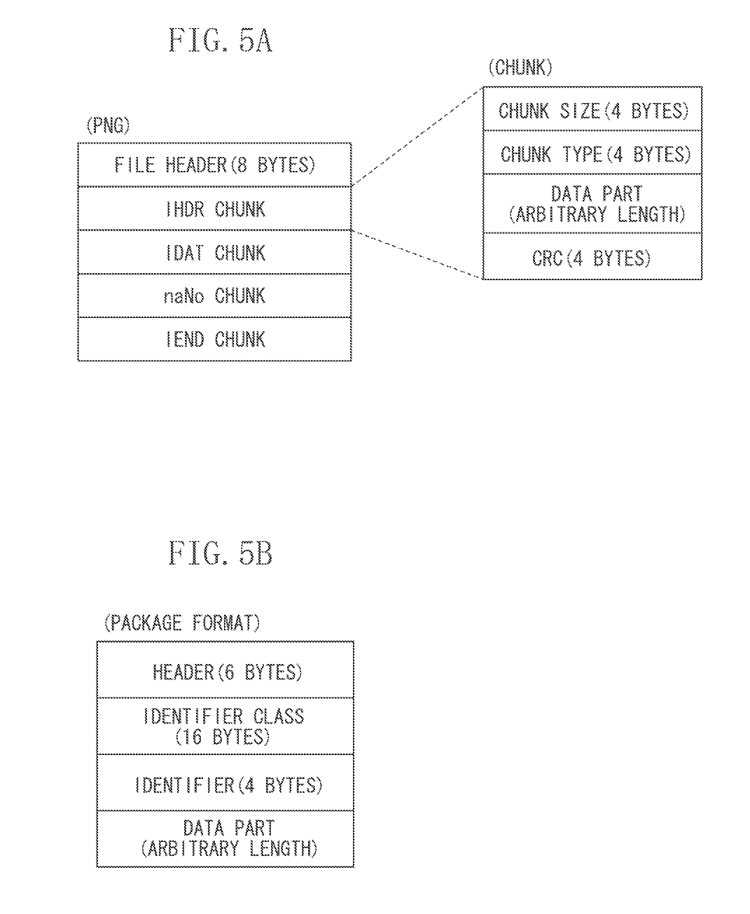

In step S102, the application 301 generates a meta image in a Portable Network Graphics (PNG) format including information about the encryption certificate. In the V3 printer driver, an encryption certificate can be transmitted from the application side to the printer driver side using ExtEscape of GDI. In the V4 printer driver, however, an encryption certificate cannot be transmitted using ExtEscape. Therefore, in the present exemplary embodiment, transmission is performed via data referred to as “meta image” in place of ExtEscape. In the meta image, the arbitrary data (metadata) is saved in an area (referred to as “expanded area” in the present specification) for storing information other than information about rendering in an image format. The meta image is image data not affecting a print result. Not affecting the print result means that, when print processing is performed based on print data converted from document data in the printer 20, no print processing is performed based on the meta image included in the document data. This will be described in detail below. In addition, a format not to be converted by the conversion module (the MXDC 302) of the document data is used as the format of the meta image. This will also be described in detail below. In the present exemplary embodiment, a PNG format is used. However, an expanded area for other formats such as Joint Photographic Experts Group (JPEG) is provided, and an image format not to be converted by the MXDC 302 as with PNG can be used as appropriate. The meta image is generated conforming to a format to be described with reference to FIGS. 5A and 5B.

FIG. 5A is a schematic diagram illustrating a data example of the meta image in the present exemplary embodiment. The image format of PNG is defined in a form including a plurality of data areas each referred to as a “chunk”, following a file header of 8 bytes. The chunk includes a chunk size (4 bytes), a chunk type (4 bytes), a data part (an arbitrary length), and a cyclic redundancy code (CRC) (4 bytes). The chunk can store various kinds of information about an image. The chunks are classified into a “critical chunk” and an “ancillary chunk”. Four types of chunks are each defined as the critical chunk. The four types are image header (IHDR), palette table (PLTE), image data (IDAT), and image trailer (IEND). The ancillary chunk can be freely defined. Whether to interpret the ancillary chunk depends on the specifications of a program. Examples of the ancillary chunk widely used include chunks for specifying an International Color Consortium (ICC) profile and a gamma correction value.

Assume that, in the present exemplary embodiment, an ancillary chunk referred to as naNo is uniquely defined to allow storage of the arbitrary data. Assume that, however, information of the arbitrary data (here, the encryption certificate, which is approximately 1 KB) is temporarily stored in a different package format (to be described below) and then stored into the naNo chunk. The meta image in the present exemplary embodiment is intended to transmit the arbitrary data. For the meta image, a size of 1×1 pixel and 24-bit color of 100% transmittance are specified so as not to affect a print result and print performance, while maintaining a minimum appearance as an image. In other words, the meta image is transparent image data. Therefore, even if the document data including the meta image is converted into the print data and then transmitted to a printer, the meta image is not rendered by the printer. Information about rendering contents, such as size and color, is stored into IDAT. An area of IDAT in the meta image is therefore a data area not affecting the print result. In the case where the 24-bit color is specified, the critical chunk PLTE is omitted. Accordingly, the meta image in the present exemplary embodiment includes the four chunks of IHDR, IDAT, naNo, and IEND.

FIG. 5B is a schematic diagram illustrating an example of the package format for storing unique data in the present exemplary embodiment. To enable transmission of the arbitrary data in a manner similar to the conventional ExtEscape, it is necessary to associate identification information with the arbitrary data. The printer driver on the receiving side can thereby distinguish the data type.

Therefore, the package format of a flexible length as illustrated in FIG. 5B is defined, and then stored into the naNo chunk. The package format includes a header (6 bytes), an identifier class (16 bytes), an identifier (4 bytes), a data size (4 bytes), and a data part (an arbitrary length). The identifier is a value agreed between a program to transmit the arbitrary data and a program to receive the arbitrary data. In the present exemplary embodiment, the data of the encryption certificate is transmitted, and therefore a value for identifying this data is agreed beforehand between the application 301 and the filter 304. The value of the identifier may be arbitrary. Therefore, the identifier class expressed in a universally unique identifier (UUID) is simultaneously specified to make the identifier unique. The value of the identifier class is also agreed beforehand between the application 301 and the filter 304.

The description will continue returning to FIG. 4. In step S103, after the meta image is generated by a generation unit, the application 301 finally transmits, with a transmission unit, the document data including the meta image and other rendering information to the conversion module (the MXDC 302) using GDI. The document data is rendered using API of GDI. Many types of API are available, such as TextOut (text), Polygon (polygon), and StretchDIBits (bitmap). The meta image is rendered using Image class and Graphics class of GDI+ in which printing of the PNG format is supported.

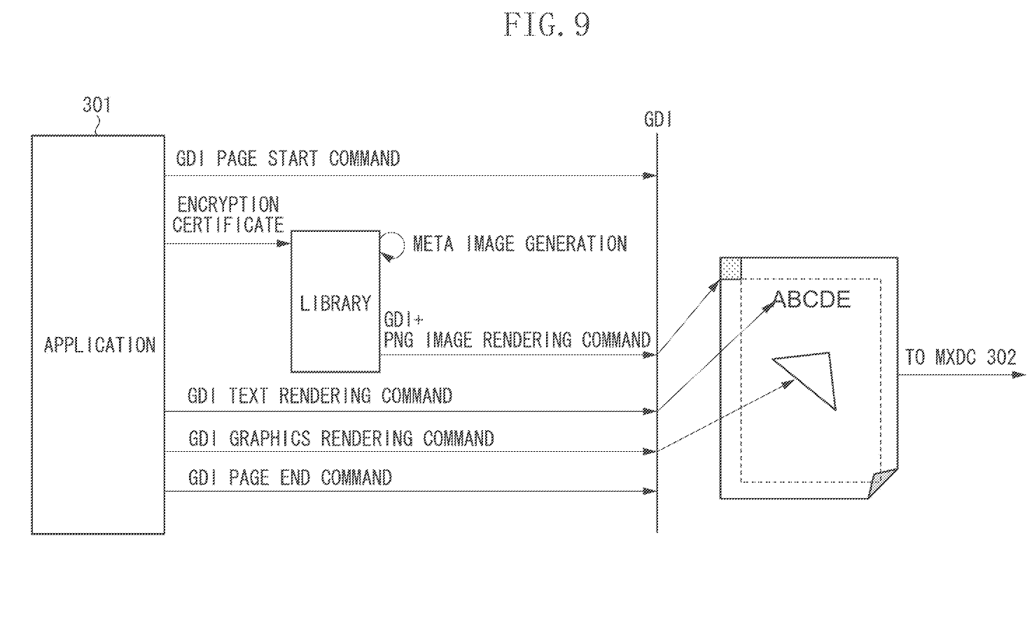

To enable support of the meta image function in various types of applications, generation processing (step S102) and transmission processing (step S103) for the meta image may be developed as an independent library component, and called from an application. FIG. 9 is a schematic diagram illustrating an example of print processing performed by the application, in a case where a meta image generation and transmission processing library component is configured.

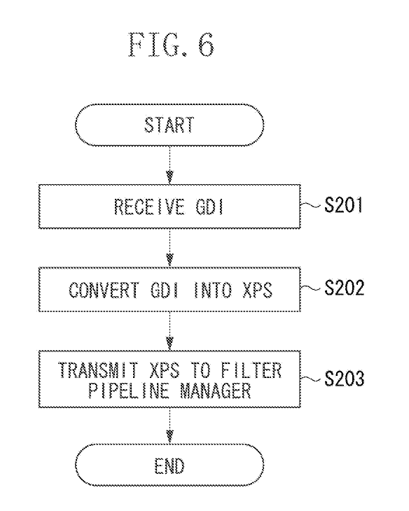

FIG. 6 is a flowchart illustrating print processing of the MXDC 302 in the present exemplary embodiment. First, in step S201, the MXDC 302 receives a rendering command of the document data transmitted from the application 301 using API of GDI. Next, in step S202, the MXDC 302 converts the format of the received document data from GDI to XPS. Subsequently, in step S203, the MXDC 302 transmits to the filter pipeline manager 303 the document data in the XPS format resulting from the conversion.

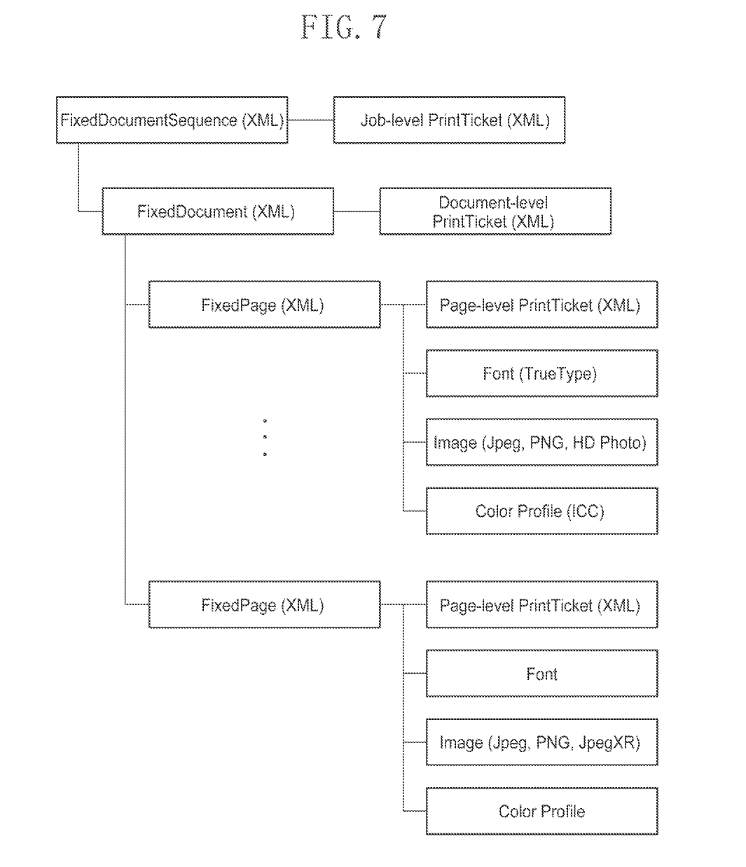

FIG. 7 is a schematic diagram illustrating a data example of the document data in the XPS format in the present exemplary embodiment. XPS is a structured document format in which pieces of data called parts are each provided as a component, and the parts are associated with each other within XPS.

The parts for defining the document structure include FixedDocumentSequence, FixedDocument, and FixedPage, each expressing an hierarchical structure of a document. Specifically, the documents expressed in the hierarchical structure by FixedDocumentSequence, FixedDocument, and FixedPage are a job, a document, and a page, respectively. In addition, a part called PrintTicket, in which a print setting is expressed in the XML format, is associated with each of the parts of the document structure. PrintTicket is referred to as Job-level PrintTicket, Document-level PrintTicket, or Page-level PrintTicket, depending on which part of the document structure is associated with PrintTicket.

Here, FixedPage is data in the XML format, in which various rendering commands predefined in XPS such as a text, graphics, and an image are described. FixedPage is associated with parts of a rendering resource to which the rendering command described in FixedPage refers. Specifically, the parts include a font, image data, and a color profile (the parts each referred to as “page part”). Jpeg, PNG, and HD Photo formats are defined for the image data in XPS. When a format different from these formats is input through GDI, the MXDC 302 converts the input format into Jpeg or PNG, and stores the result of this conversion into XPS as parts. Examples of the other formats include device independent bitmap (DIB). However, when Jpeg or PNG is input using API of GDI+, conversion to other formats is unnecessary, and therefore the MXDC 302 stores the input format as-is into XPS. For this reason, the metadata in the meta image input from the application 301 is stored into XPS without being lost.

When the filter pipeline manager 303 receives the document data in the XPS format from the conversion module (the MXDC 302), processing of the filter pipeline manager 303 starts. The filter pipeline manager 303 receives the document data in the XPS format and loads the filter 304. Then, the filter pipeline manager 303 transmits the received document data in the XPS format to the filter 304. The filter 304 of the printer driver therefore receives the document data from the application 301, via the MXDC 302 and the filter pipeline manager 303.

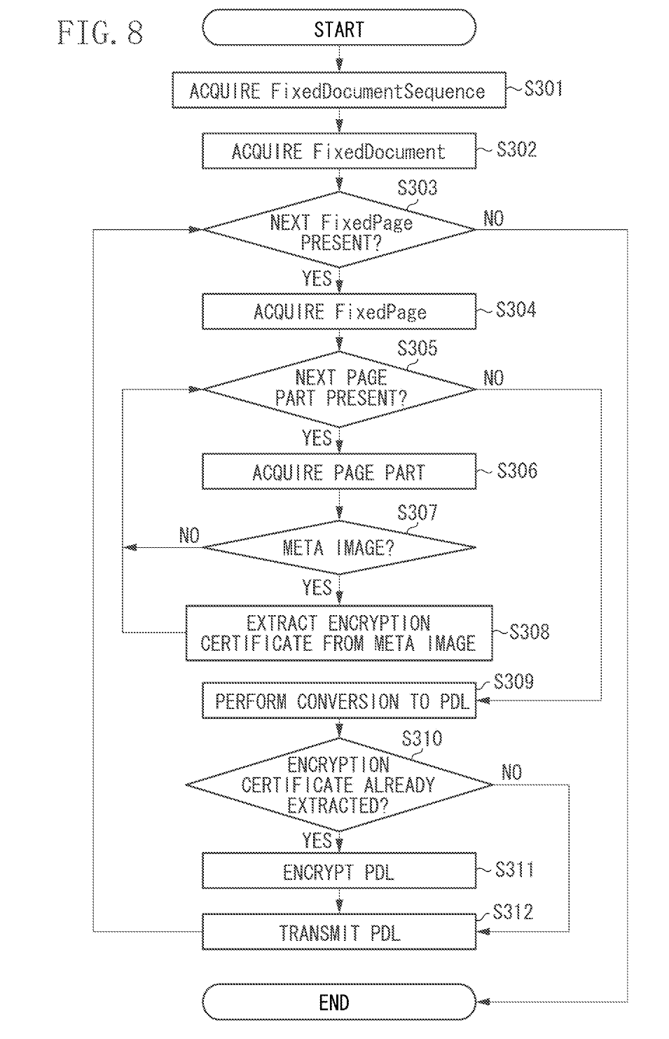

FIG. 8 is a flowchart illustrating print processing after the filter 304 of the printer driver receives the document data in the XPS format in the present exemplary embodiment.

In step S301, upon receiving document data in the XPS format, the filter 304 acquires FixedDocumentSequence at the highest level of the document structure from within XPS by a receiving unit. In step S302, the filter 304 acquires FixedDocument at a level immediately below the highest level. Subsequently, in step S303 and step S304, the filter 304 acquires FixedPage at a level below FixedDocument for all the existing parts (for all the number of pages). Specifically, in step S303, the filter 304 determines whether the next FixedPage is present. When the next FixedPage is present (YES in step S303), the processing proceeds to step S304, and if not (NO in step S303), the processing ends. In step S304, the filter 304 acquires the next FixedPage.

The filter 304 as a determination unit determines whether a meta image is present in the document data, and performs processing for acquiring metadata as an acquisition unit from the meta image when the meta image is determined to be present. Specifically, after acquiring FixedPage in step S304, the filter 304 performs the following. In step S305, the filter 304 determines whether a next page part is present. If the next page part is present (YES in step S305), then in step S306, the filter 304 acquires a page part associated with the next FixedPage. In step S307, the filter 304 determines whether an image is the meta image if the acquired page part is an image in the PNG format. Specifically, in step S307, the filter 304 determines whether the image is the meta image by checking whether the ancillary chunk naNo is present. If the image is the meta image (YES in step S307), the processing proceeds to step S308. In step S308, the filter 304 acquires the package format described with reference to FIG. 5B from the meta image, thereby acquiring the metadata, i.e., the encryption certificate data.

In step S309, the filter 304 converts FixedPage and the page part into PDL, after acquiring all the page parts. In step 3310, the filter 304 determines whether the encryption certificate is already extracted. If the filter 304 determines that the encryption certificate is already extracted (YES in step S310), i.e., if step S308 is executed, the processing proceeds to step S311. In step S311, the filter 304 encrypts the PDL based on the extracted encryption certificate. Subsequently, in step S312, the filter 304 transmits the encrypted PDL to the spooler 305. When the encryption certificate is not yet extracted (NO in step S310), the filter 304 transmits the PDL to the spooler 305 without encrypting the PDL. In this way, the printer driver converts the document data into the print data, and transmits the print data to the printer 20 via the spooler 305 and the port monitor 306. This ends the description of the print processing in the present exemplary embodiment.

In the present exemplary embodiment, the processing for transmitting the encryption certificate is described. In communication using a meta image, an application can transmit arbitrary information to a printer driver, and control printing. For example, the present embodiment is applicable to PostScript Pass-Through in the V3 printer driver. The present embodiment is also applicable to a use case of transmitting API for a rendering instruction of GDI such as a halftone copy-forgery-inhibited pattern image, and information incapable of being expressed in XPS.

In addition, the meta image may be transmitted a plurality of times in one job or in one page. In a case where the meta image is transmitted a plurality of times in one page, a different rendering attribute may be provided to each meta image to prevent the meta image from being eliminated by the MXDC 302 as a redundant image during the conversion to XPS. Specifically, control is performed to change a rendering position and a color (RGB components except for transparent components) of each meta image. Alternatively, the size of the meta image may be freely changed within a range of, for example, about ten pixels.

The meta image has been described above as an image having pixels of a transparent color. However, a system can be configured using other schemes for preventing an influence on a print result regardless of a pixel color. For example, the meta image may be placed in an area where the document data is not rendered. Specifically, the rendering position of the meta image may fall outside an area of a print sheet without fail, or a clip may be specified to prevent the meta image from being rendered. Alternatively, when the page part is determined to be the meta image in step S307, the meta image may be deleted from the document data in the XPS format, after the metadata has been acquired from the meta image in step S308. This prevents the conversion into PDL.

The method for preventing the printer from performing printing based on the meta image has been described above. However, other images that hardly affect the print result may be adopted. Specifically, the size of the meta image may be a 1×1 pixel of yellow close to white, and this pixel may be placed in a white background in a rendering area of the document data.

Moreover, in the present exemplary embodiment, the print system for transmitting PDL to the printer and causing the printer to perform printing has been described as an example. However, the embodiment is also applicable to an information system on which other types of printer drivers is installed. For example, the embodiment may be applied to a system such as a document system including a virtual V4 printer driver that converts a print instruction from an application into PDF, and stores the PDF into a file.

According to the present exemplary embodiment, communication of arbitrary data between an application and a printer driver can be implemented regardless of the version of the print system.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. The various units of an embodiment can be implemented by one or more processors, a processor executing instructions in a software module associated with each unit, or a software module associated with each unit. Examples of such include but are not limited to: a receiving unit; a determination unit; an acquisition unit; a generation unit; a transmission unit; and other units which implement a instructions for performing portions of a method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-034835, filed Feb. 25, 2016, which is hereby incorporated by reference herein in its entirety.

What is claimed is:

1. An information processing apparatus, comprising:
a memory; and
one or more processors, wherein the one or more processors are configured to implement a printer driver;
wherein the printer driver comprises:
a receiving unit configured to receive document data,
a determination unit configured to determine whether a meta image is present in the document data, wherein the meta image in which metadata is saved in an area for storing information different from information about rendering an image, and
an acquisition unit configured to acquire the metadata included in the meta image from the document data, in a case where the determination unit determines that the meta image is present in the document data.

2. The information processing apparatus according to claim 1, wherein the printer driver converts the document data into print data to transmit the print data to a printer, and print processing based on the meta image is not performed in the printer that has received the print data.

3. The information processing apparatus according to claim 1, wherein the meta image is transparent image data.

4. The information processing apparatus according to claim 1, wherein the printer driver deletes the meta image from the document data, after the acquisition unit has acquired the metadata from the meta image.

5. The information processing apparatus according to claim 1, further comprising an application, wherein the application comprises:
a generation unit configured to generate the meta image, and
a transmission unit configured to transmit document data including the meta image.

6. The information processing apparatus according to claim 5, wherein the application places the meta image in an area where the document data is not rendered.

7. The information processing apparatus according to claim 5,
wherein the generation unit generates the meta image in a format not to be converted by a conversion module of the document data,
wherein the transmission unit transmits the document data including the meta image to the conversion module, and
wherein the receiving unit receives the document data from the conversion module.

8. A control method for an information processing apparatus including a printer driver, the control method comprising:
receiving document data;
determining whether a meta image is present in the document data, wherein the meta image in which metadata is saved in an area for storing information different from information about rendering an image; and
acquiring the metadata included in the meta image from the document data, in a case where the determining determines that the meta image is present in the document data.

9. The control method according to claim 8, wherein the printer driver converts the document data into print data to transmit the print data to a printer, and print processing based on the meta image is not performed in the printer that has received the print data.

10. The control method according to claim 8, wherein the meta image is transparent image data.

11. The control method according to claim 8, wherein the printer driver deletes the meta image from the document data, after the acquiring acquires the metadata from the meta image.

12. The control method according to claim 8, further comprising an application, wherein the application comprises a method for:
generating the meta image, and
transmitting document data including the meta image.

13. The control method according to claim 12, wherein the application places the meta image in an area where the document data is not rendered.

14. The control method according to claim 12,
wherein the generating generates the meta image in a format not to be converted by a conversion module of the document data,
wherein the transmitting transmits the document data including the meta image to the conversion module, and
wherein the receiving receives the document data from the conversion module.

15. A non-transitory storage medium storing a program for causing an information processing apparatus including a printer driver to execute a control method, the method comprising:
receiving document data;
determining whether a meta image is present in the document data wherein the meta image in which metadata is saved in an area for storing information different from information about rendering an image; and
acquiring the metadata included in the meta image from the document data, in a case where the determining determines that the meta image is present in the document data.

16. The non-transitory storage medium according to claim 15, further storing an application wherein the application comprises a method for:
generating the meta image, and
transmitting document data including the meta image.
